(19) United States
(12) Patent Application Publication
(10) Pub. No.: US 2007/0092820 A1
(43) Pub. Date: Apr. 26, 2007

(54) Toner with enhanced fuser release properties

(75) Inventors: Michael James Bensing, Lexington, KY (US); Gerald Hugh Ciecior, Westminster, CO (US); Lale Gokbudak Lovell, Longmont, CO (US); John Melvin Olson, Boulder, CO (US); Robert Glenn Smith, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/256,302

(22) Filed: Oct. 21, 2005

(51) Int. Cl. G03G 9/08

(52) U.S. Cl. 430/108.4; 430/110.3; 430/137.14; 430/111.4; 430/110.1

(57) ABSTRACT

The crystalline state of the release wax of an electrophotographic toner is made so that the crystalline state has the highest melt transition temperature. In an embodiment, this is done by synthesizing the toner particles at a controlled low temperature, the temperature being that found consistent with subsequent cooling to just the crystalline state of having the highest melt transition temperature. Chemically prepared toner by agglomeration is well suited to employing this. In such a system agglomerated particles are suspended in a liquid medium. The particles are then heated while so suspended to fuse the particles into a mixture constituting toner. That fusing is conducted at the foregoing controlled temperature.

### FIELD OF THE INVENTION

This invention relates to toners employed as dry particulates to develop electrostatic images and then fused while under pressure and heat.

### BACKGROUND OF THE INVENTION

Toners for electrophotographic printers can be made by a conventional process involving a melt mix of resin(s), wax(es), pigment(s), and other additives. This material is then subjected to a grinding process, which produces toner particles of roughly 10 microns. Smaller sizes can be achieved through this method, however limitations exist. The chemically produced toner (CPT) process can be performed by emulsion aggregation, suspension, or chemical milling. Chemically producing toner allows a smaller particle size toner to be produced that has tighter control of the particle shape and the particle size distribution. United States Patent Pub. No. 2004/0137348 A1, by Beach and Sun describes such emulsion aggregation chemically produced toner.

In use, the toner is transferred from a photoconductor to paper or other sheet by one or more steps and then typically fused into the sheet by melting under pressure and heating. One important characteristic of the toner is the fuse window. The fuse window is the range of temperature at which the fusing is satisfactorily conducted without incomplete fusion and without transfer of toner to the heating element, which may be a roller, belt or other member contacting the toner during fusing. Thus, below the low end of the fuse window the toner is incompletely melted and above the high end of the fuse window the toner flows onto the fixing member, where it mars subsequent sheets being fixed.

Some waxes used as release waxes in toner have satisfactory fuse windows, but are not ideal in other respects, such as filming on other surfaces such as a doctor blade, a developer roller or other member. This invention is to formulate toner with release waxes with a satisfactory fuse window and which may have excellent other characteristics. This invention is based on controlling a wax capable of having multiple crystalline phases to be at a single, highest-melting crystalline phase. The wax denominated 21 U.S. Pat. No. 6,841,325 B2 to Jeda et al. is substantially the same as the preferred wax are isolated and used.

### BRIEF DESCRIPTION OF THE DRAWINGS

The details of this invention will be described in connection with the accompanying drawings, in which

FIG. 1 is the plotted results of a standard differential scanning calorimeter (DSC) heating ramp (temperature versus watts per gram) showing the development of a second crystalline phase in a wax after cycling to a high temperature and cooling to normal room temperature;

FIG. 2 is the plotted results of a standard differential scanning calorimeter heating ramp showing a toner with a release wax which was heated to a higher temperature during formulation (normal conditions absent this invention) and another toner which was heated at a lower temperature and then cooled to normal room temperature; and

FIG. 3 is a plot of two corresponding toners, one cooled from a preselected temperature low enough to permit the recrystallization of the wax to selectively create a crystalline phase possessing higher melt temperature and greater heat of fusion character.

### SUMMARY OF THE INVENTION

This invention employs the crystalline state of the release wax in a toner to increase the fuse window. Waxes may have one or more crystalline states. In a normal condition having cooled from temperatures well above the highest melting of the crystalline states, the wax will crystallize into more than one of these states. Each crystalline state has a different heat of fusion and melt temperature. Wax which is all in the highest melt state will have the greatest heat of fusion.

In accordance with this invention, prior to use of the toner, the crystalline state of the release wax is made to that of the highest melt transition temperature. In an embodiment, this is done by synthesizing the toner particles at a controlled low temperature, the temperature being that found consistent with subsequent cooling to yield just the crystalline state of having the highest melt transition temperature.

Chemically prepared toner by agglomeration is well suited to employing this invention. In such a system, agglomerated particles are suspended in a liquid medium. The particles are then heated, while so suspended to fuse the particles into a mixture constituting toner. That fusing may be conducted at the foregoing controlled temperature to achieve a toner with release wax that is substantially all in the crystalline state having the highest melt transition temperature. The liquid is subsequently removed to leave the toner particles for use in dry form.

Toners are distinguished by having a binder resin mixed with a pigment or other imaging material. The imaging material need not be visible where sensing is to be by ultra violet or other non-visual sensing.

### DESCRIPTION OF THE PREFERRED EMBODIMENTS

In the preferred embodiments very large increase in fuse window is obtained using a wax that can exist in several crystalline phases. FIG. 1 is a differential scanning calorimeter (DSC) plot which identifies the crystal phases of a wax. The heat of fusion is the energy absorbed by a crystalline substance to change in phase from solid to liquid. As is well understood, this corresponds to an endothermic peak in the DSC plot. The wax employed to produce FIG. 1 was a fatty acid ester of neopentylpolyol sold commercially by NOF Corporation as WE-6.

The graph evidenced by black dots in FIG. 1 is the wax in an initial condition carefully treated to have a single crystalline phase. This is shown in the plot as a single large peak. This was heated to the normal, high level consistent with toner manufacture and then cooled to room temperature. The graph evidenced by open squares in FIG. 1 is that wax after the cooling once again scanned by DSC. A second endothermic peak has developed at about the 60 degree location, evidencing a second crystalline phase.

In accordance with this invention certain process changes are conducted to select a specific crystalline phase or a combination of crystalline phases that gives us the widest release window and the best developing and fusing characteristics. A few of the variables that impact the selection of the best crystalline phase of the wax may include the type and amount of pigment, the type and amount of dispersant, pH, and temperature.

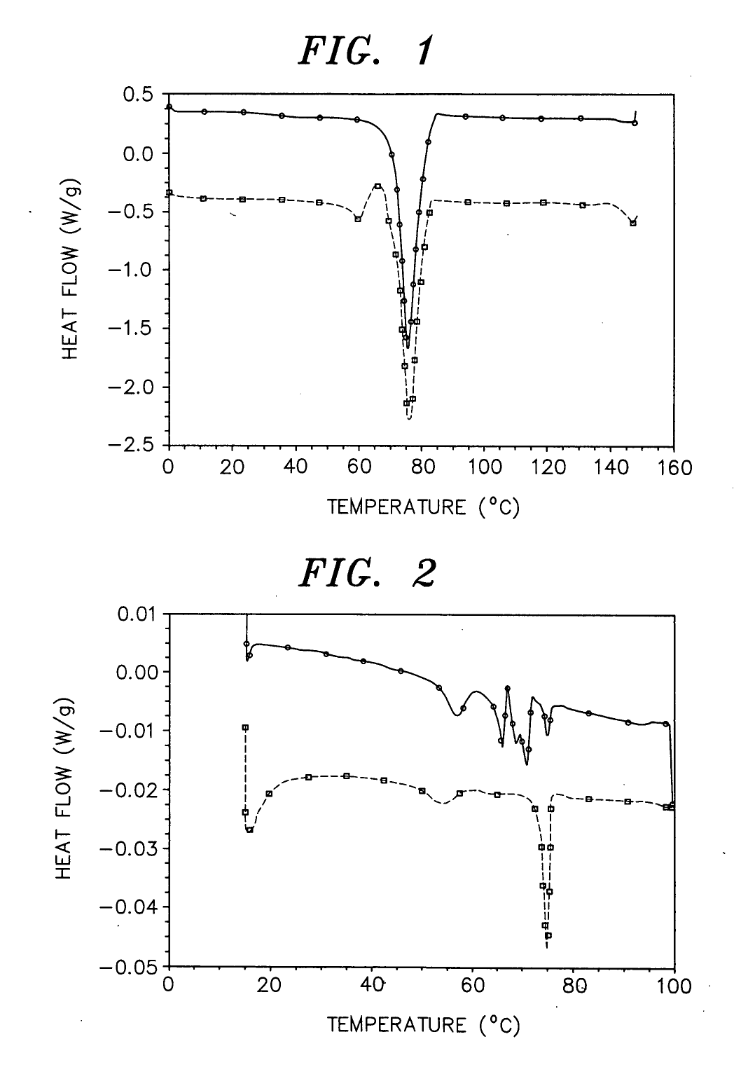

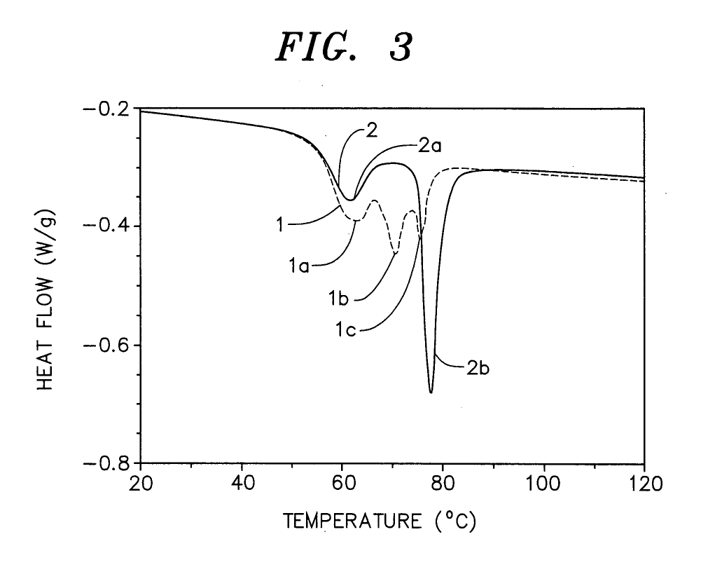

Using WE-6 wax, a variety of fusing performances appeared dependent upon the variables just mentioned. When the crystalline form of this wax is in a single phase at the highest possible melt temperature, the fusing window is increased dramatically. In FIG. 2 as seen in the graph evidenced by black dots is a magenta toner having WE-6 wax. The wax has at least four crystalline phases. The second toner in FIG. 2 (having yellow pigment), evidenced by open squares, otherwise corresponds to the magenta toner, but has only one crystalline phase of WE-6 wax. The fuse window was 5° C. for magenta toner and 30° C. for yellow toner.

The WE-6 wax is an attractive candidate in that it has robust performance in a toner mixture, including resistance to doctor blade and developer roll filming. Initially, the only drawback of the wax was a very small fuse window (essentially none, compared to 40 degrees C. for a preferred linear polyethylene wax). Now a fuse window comparable to a toner with a linear polyethylene wax is achieved when the wax is a single phase at the highest possible melt state (high melt state).

### Controlling the Crystalline State of the Wax

DSC of in-process chemically prepared toner examined from different temperatures during the agglomeration process suggested that the high melt state of WE-6 wax was preserved in the samples that were not heated above 70° C. Based on these results, a series of cyan toners were prepared in which the maximum temperature during formulation was limited to either 66° or 72° C.

### EXAMPLE 1

Toner: 88 g of cyan pigment dispersion (10.3% solids), comprised of Pigment Blue 15:3 and a dispersant consistent with those of the foregoing US Pub.2004/0137348 A1 in a 5:1 weight ratio, was mixed with 72 g of wax dispersion (16.8% solids), consisting of WE-6 wax and the same dispersant in a 2.87:1 weight ratio and 273 mL of distilled water in a stainless steel beaker. Using a homogenizer, the materials were thoroughly mixed and 303 g of styrene-acrylic type latex (42.6% solids) was slowly added. Once the latex was added, 233 g of isopropyl alcohol was quickly added to the mixture. Finally, 375 g of a 1% nitric acid solution was slowly dripped into the beaker over 15 minutes to decrease the pH to 1.8. The contents of the beaker were then transferred to a 2 L reactor and stirred. The mixture was then heated to 72° C. and held for 90 minutes. The final median particle size was 8.9 um (by volume) and the final wax level was estimated to be 6% by weight. The solid toner was washed at least 4 times with distilled water and then dried in an oven at 43° C. for 2 days.

### EXAMPLE 2

This Example 2 is identical to Example 1 except for the temperature and period of heating.

Toner: 88 g of cyan pigment dispersion (10.3% solids), comprised of Pigment Blue 15:3 and the dispersant of Example 1 in a 5:1 weight ratio, was mixed with 72 g of wax dispersion (16.8% solids), consisting of WE-6 wax and the same dispersant in a 2.87:1 weight ratio and 273 mL of distilled water in a stainless steel beaker. Using a homogenizer, the materials were thoroughly mixed and 303 g of styrene-acrylic type latex (42.6% solids) was slowly added. Once the latex was added, 233 g of isopropyl alcohol was quickly added to the mixture. Finally, 375 g of a 1% nitric acid solution was slowly dripped into the beaker over 15 minutes to decrease the pH to 1.8. The contents of the beaker were then transferred to a 2 L reactor and stirred. The mixture was then heated to 66° C. and held for 100 minutes. The final median particle size was 9.5 um (by volume) and the final wax level was estimated to be 6% by weight. The solid toner was washed at least 4 times with distilled water and then dried in an oven at 43° C. for 2 days.

First scan DSC of the final toner samples are shown in FIG. 3. Plot 1 is that of the toner of Example 1. Plot 2 is that of the toner of Example 2. The lowest-temperature transitions, 1a in plot 1 and 2a in plot 2, are from glass transition of the latex binder. The two endothermic peaks, 1b and 1c in plot 1, are from multiple crystalline states of the wax. Plot 2 contains only one such endothermic peak, 2b, which appears at a temperature higher than either 1b or 1c.

Thus, plot 2 verifies that the toner held at 66° C. (Example 2) only contained the high-melt state of the WE-6 wax whereas plot 1 shows that the other toner (Example 1) was a mixture of lower melt states. Microscopy analysis of the resultant toner demonstrated that the particles possessed completely different wax-domain morphology due to hold temperature.

Functional print testing of the samples showed that the 6% WE-6 wax, 72° C. rounding temperature sample (Example 1) only had a release window of 5° C. (130-135° C.) on 24# paper whereas the 6% WE-6 wax, 66° C. rounding temperature sample (Example 2) possessed a 45° C. (130-175° C.) release window on #24 paper, a nine times increase. For this purpose, release window is defined as the temperature required to achieve adequate fuse grade up to the temperature at which hot offset to the fuser occurs.

In summary, the release window of toner containing WE-6 wax can be dramatically improved by controlling the crystalline state of the wax in the final agglomerated toner particle. As described in the examples above, one way to do this is to maintain strict temperature control during the agglomeration process. By keeping the temperature during the agglomeration at 68-70° C. or below, the wax does not re-crystallize into lower melt states and the release window of the final toner remains broad.

What is claimed is:

1. A powder electrostatic toner comprising a mixture of a binder resin, an imaging material and a wax release agent, said wax having multiple crystalline phases after undergoing cooling from melting at a temperature above a predetermined temperature at which said wax cools to a single crystalline phase, wherein said wax is substantially entirely in the crystallize phase of said wax which exhibits the highest melt transition temperature as compared to the other crystallize phases of said wax.

2. The toner of claim 1 in which said wax is a fatty acid ester of neopentylpolyol

3. The toner of claim 1 in which said toner comprises generally rounded powder resulting from melting particles of said binder, said imaging material and said wax while said particles are suspended in a liquid and then removing said liquid.

4. The toner of claim 2 in which said toner comprises generally rounded powder resulting from melting particles of said binder, said imaging material and said wax while said particles are suspended in a liquid and then removing said liquid.

5. A method of forming a particulate toner comprising:
forming an aggregate in a liquid medium of binder resin, imaging material, and wax release agent,
heating said aggregate in said liquid medium at a predetermined temperature at which the crystalline phase with the highest melt transition temperature of said wax is formed at cooling,
cooling said liquid, and then
removing said liquid.

6. The method of claim 5 in which said wax is a fatty acid ester of neopentylpolyol.
